(19) United States
(12) Patent Application Publication
(10) Pub. No.: US 2025/0348531 A1
(43) Pub. Date: Nov. 13, 2025

(54) SEARCH DEVICE, SEARCH METHOD, AND COMPUTER READABLE MEDIUM

(71) Applicant: Mitsubishi Electric Corporation, Tokyo (JP)

(72) Inventors: Ryoji HATTORI, Tokyo (JP); Takayuki KODAIRA, Tokyo (JP); Eiji YAMAMOTO, Tokyo (JP); Kohei MOCHIZUKI, Tokyo (JP); Yoko TANOUCHI, Tokyo (JP); Masato SABANAI, Tokyo (JP)

(73) Assignee: Mitsubishi Electric Corporation, Tokyo (JP)

(21) Appl. No.: 19/277,111

(22) Filed: Jul. 22, 2025

Related U.S. Application Data
(63) Continuation of application No. PCT/JP2023/011355, filed on Mar. 23, 2023.

(51) Int. Cl. G06F 16/535; G06F 16/55

(52) U.S. Cl. CPC G06F 16/535; G06F 16/55

(57) ABSTRACT

By taking each of a plurality of clusters obtained by clustering a plurality of feature values stored in a feature database (48) as a target cluster, a threshold deriving unit (47) derives a threshold for the target cluster from a distribution of the feature values in the target cluster. By using, as a target threshold, a threshold for a cluster to which a search feature, which is a feature value for an image in a search request, belongs among the plurality of clusters, a search unit (44) identifies a feature value corresponding to the search feature from the plurality of feature values stored in the feature database (48).

### CROSS REFERENCE TO RELATED APPLICATION

This application is a Continuation of PCT International Application No. PCT/JP2023/011355, filed on Mar. 23, 2023, which is hereby expressly incorporated by reference into the present application.

### TECHNICAL FIELD

The present disclosure relates to a technology for searching for a target object appearing in image data acquired by a camera taking a target space as an image-taking area by taking an image of the target object as a search key.

### BACKGROUND ART

In a space where many people gather, for example, a large-scale facility such as a station, airport, or commercial facility, or a block of an urban area, means for searching for a specific person is required.

This means is required at the time of performing, for example, a search for a lost child, a wandering person, a person straying away from an accompanying person, or the like based on a request from a space user. This means is required also at the time of performing a search for a user not appearing at a designated location although a reservation time or time of entrance comes. This means is required also at the time of performing a search for a user whose gear is recognized as being left or whose formalities are recognized as inadequate after leaving a shop. Furthermore, in view of crime prevention, this means is required at the time of identifying the position of a fleeing shoplifter, molester, assailant, or the like for arrest or at the time of analyzing the behavior of a primary person of interest in crime investigation.

In a space where many people gather, many network cameras are often installed for the purpose of crime prevention. Thus, a person search process has been discussed in which a feature value of a person is extracted from camera video and, by taking the feature value as a key, a search is performed in live video or recorded video to know when and on which camera a search target person appeared. The live video is real-time video.

The feature value of a person extractable from camera video is the following (1) to (4) and so forth.

(1) A verbalizable feature such as the color and shape of a cloth or gear, the build and stature, gender, or age. (2) An image feature such as HoG. HoG is an abbreviation of Histograms of Oriented Gradients. (3) Vector data, typified in face recognition technology, obtained by converting a facial feature of a person into a comparative form. (4) Vector data obtained by converting a feature of the whole body of a person into a comparable form.

In a person search, a person identifying process is used in which, if a distance between feature values for two person images is equal to or smaller than a threshold, the two person images are determined as images of the same person. Here, in a person search process using feature values, a difference occurs in the distance between feature values due to a difference in the outer appearance of the person, the camera image-taking condition, or the like. As a result, there is a possibility of occurrence of “erroneous search”, in which a search is performed for an erroneous person, and “search omission”, in which a person to be searched for is omitted from the search results.

In Patent Literature 1, a technology for solving a problem due to a difference in image-taking conditions is described. In Patent Literature 1, in a process of identifying a face, a problem resides in that a threshold of similarity of face feature values differs depending on the combination of cameras. And, to address this problem, in Patent Literature 1, after a person is identified with another logic, an error rate of face feature matching is calculated by taking the identification result as a correct answer, and the threshold is adjusted so that the error rate is constant for each combination of cameras.

### Citation List

### Patent Literature

Patent Literature 1: JP 2020-187531

### SUMMARY OF INVENTION

### Technical Problem

The technology described in Patent Literature 1 is a technology strictly to set a threshold for each combination of cameras.

However, an optimum threshold varies for each outer appearance of a person as a target. For example, a distribution of feature values of persons dressed in deep color on both of the upper and lower bodies is small, and a distribution of persons dressed in light color on the upper body and in deep color on the lower body is large. In this case, for the persons dressed in deep color on both of the upper and lower bodies, a relatively smaller value can be set as a threshold than that for the persons dressed in light color on the upper body and in deep color on the lower body. Thus, in the technology described in Patent Literature 1, erroneous detection or search omission cannot be fully prevented, and there is a possibility that a person search cannot be appropriately performed.

The present disclosure has an object of allowing a target object appearing in image data to be appropriately searched for.

### Solution to Problem

A search device according to the present disclosure includes:
a threshold deriving unit to derive, by taking each of a plurality of clusters obtained by clustering a plurality of feature values stored in a feature database as a target cluster, a threshold for the target cluster from a distribution of the feature values in the target cluster; and
a search unit to identify, by using, as a target threshold, the threshold derived by the threshold deriving unit for a cluster to which a search feature, which is a feature value for an image in a search request, belongs among the plurality of clusters, a feature value corresponding to the search feature from the plurality of feature values stored in the feature database.

### Advantageous Effects of Invention

In the present disclosure, a threshold is derived in advance for each cluster obtained by clustering feature values, and a search is performed by using a threshold for a cluster corresponding to a search feature. With this, a search is performed by using an appropriate threshold corresponding to the search feature, and a target object can be appropriately searched for.

### BRIEF DESCRIPTION OF DRAWINGS

FIG. 1 is a diagram of structure of a search system 100 according to Embodiment 1.

FIG. 2 is a diagram of hardware structure of a feature extracting device 30 and a search device 40 according to Embodiment 1.

FIG. 3 is a flowchart of a collecting process according to Embodiment 1.

FIG. 4 is a flowchart of a search process according to Embodiment 1.

FIG. 5 is a descriptive diagram of a threshold database 49 according to Embodiment 1.

FIG. 6 is a descriptive diagram of clusters according to Embodiment 1.

FIG. 7 is a flowchart of a threshold deriving process according to Embodiment 1.

FIG. 8 is a descriptive diagram of effects of the search system 100 according to Embodiment 1.

### DESCRIPTION OF EMBODIMENTS

### Embodiment 1

In Embodiment 1, a case is described in which a human is taken as a target object. That is, in Embodiment 1, a case is described in which a human is searched for. However, the target object is not limited to a human but may be an animal such as a dog or cat or a physical object such as a bag.

### Description of Structure

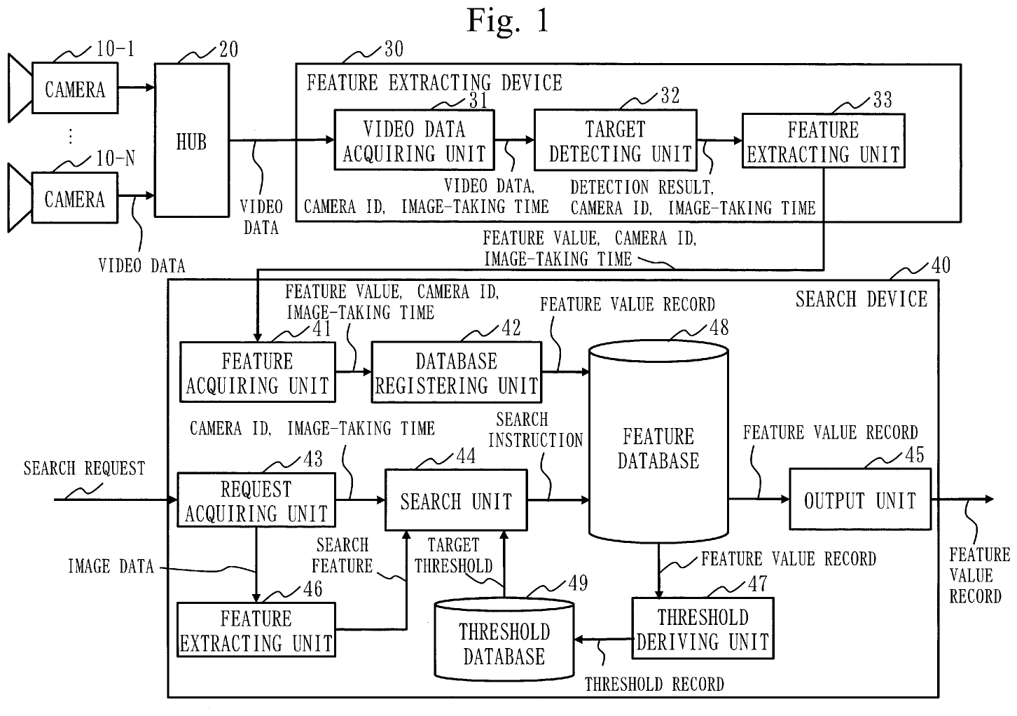

With reference to FIG. 1, the structure of a search system 100 according to Embodiment 1 is described.

The search system 100 includes a plurality of cameras 10, a hub 20, a feature extracting device 30, and a search device 40. In FIG. 1, the search system 100 includes N cameras 10 from a camera 10-1 to a camera 10-N as the cameras 10. N is an integer equal to or larger than 2.

Each camera 10 and the hub 20 are connected via a transmission path. The hub 20 and the feature extracting device 30 are connected via a transmission path. The feature extracting device 30 and the search device 40 are connected via a transmission path.

The camera 10 is installed at a location in a target space where a person search is performed. The camera 10 takes video of a person moving in the target space. The camera 10 transmits the taken video to the hub 20 via a transmission path such as an IP network. IP is an abbreviation of Internet Protocol. Each camera 10 may be arranged without sharing a field of vision. That is, in the target space, a dead angle not taken by the camera 10 may be present.

In Embodiment 1, the camera 10 is assumed to be an IP camera that compresses video for transfer via an IP network. However, the camera 10 may be a camera that transfers an uncompressed video signal via a coaxial cable or may be a camera using another transfer method.

The hub 20 receives video data transmitted from the camera 10 and transmits the video data to the feature extracting device 30.

When the cameras 10 are connected to the internet using a public line and transmit video data to the internet, the structure may be such that the feature extracting device 30 also connected to the internet receives video data via the internet. In this structure, the internet corresponds to the hub 20. Also, when the data transmission method of the cameras 10 is based on a protocol other than the IP, the hub 20 is an intensive device corresponding to that protocol.

The feature extracting device 30 is a computer that extracts a feature value usable for person identification from a person appearing in video data obtained by the camera 10.

The feature extracting device 30 includes a video data acquiring unit 31, a target detecting unit 32, and a feature extracting unit 33 as functional components.

The search device 40 is a computer that searches for a person in response to a search request from a user. In Embodiment 1, the search device 40 has a database function of managing a feature value of a person for searching. Note that the database function may be implemented by a device outside the search device 40.

The search device 40 includes a feature acquiring unit 41, a database registering unit 42, a request acquiring unit 43, a search unit 44, an output unit 45, a feature extracting unit 46, and a threshold deriving unit 47 as functional components. Also, the search device 40 includes a feature database 48 and a threshold database 49 as database functions.

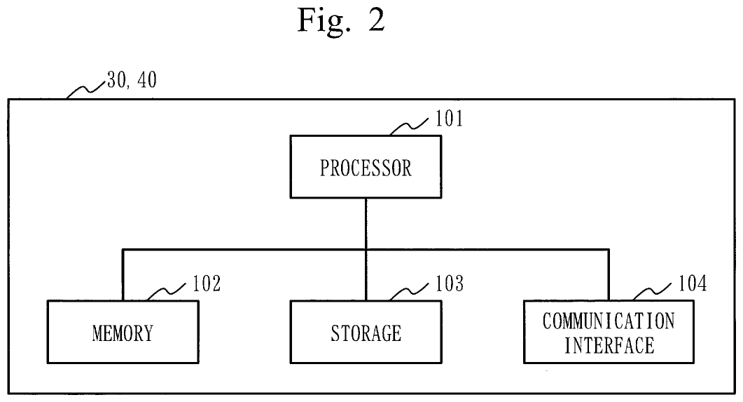

With reference to FIG. 2, the hardware structure of the feature extracting device 30 and the search device 40 according to Embodiment 1 is described.

The feature extracting device 30 and the search device 40 each have hardware including a processor 101, a memory 102, a storage 103, and a communication interface 104. The processor 101 is connected to other pieces of hardware via a signal line to control these other pieces of hardware.

The processor 101 is an IC that performs processing. IC is an abbreviation of Integrated Circuit. The processor 101 is, as a specific example, a CPU, DSP, or GPU. CPU is an abbreviation of Central Processing Unit. DSP is an abbreviation of Digital Signal Processor. GPU is an abbreviation of Graphics Processing Unit.

The memory 102 is a storage device that temporarily stores data. The memory 102 is, as a specific example, an SRAM or DRAM. SRAM is an abbreviation of Static Random Access Memory. DRAM is an abbreviation of Dynamic Random Access Memory.

The storage 103 is a storage device that retains data. The storage 103 is, as a specific example, an HDD. HDD is an abbreviation of Hard Disk Drive. Also, the storage 103 may be a portable recording medium such as an SD (registered trademark) memory card, CompactFlash (registered trademark), NAND flash, flexible disk, optical disk, compact disk, Blu-ray (registered trademark) disk, or DVD. SD is an abbreviation of Secure Digital. DVD is an abbreviation of Digital Versatile Disk.

The communication interface 104 is an interface for communication with an external device. The communication interface 104 is, as a specific example, an Ethernet (registered trademark), USB, or HDMI (registered trademark) port. USB is an abbreviation of Universal Serial Bus. HDMI is an abbreviation of High-Definition Multimedia Interface.

The function of each functional component of the feature extracting device 30 and the search device 40 is implemented by software.

In the storage 103 of the feature extracting device 30, a program that implements the function of each functional component of the feature extracting device 30 is stored. In the feature extracting device 30, this program is read by the processor 101 to the memory 102, and is executed by the processor 101. With this, the function of each functional component of the feature extracting device 30 is implemented.

Similarly, in the storage 103 of the search device 40, a program that implements the function of each functional component of the search device 40 is stored. In the search device 40, this program is read by the processor 101 to the memory 102, and is executed by the processor 101. With this, the function of each functional component of the search device 40 is implemented.

The storage 103 of the search device 40 implements a database function.

In FIG. 2, only one processor 101 is depicted. However, the feature extracting device 30 and the search device 40 may each include a plurality of processors 101, and the plurality of processors 101 may execute a program for implementing each function in cooperation with each other.

### Description of Operation

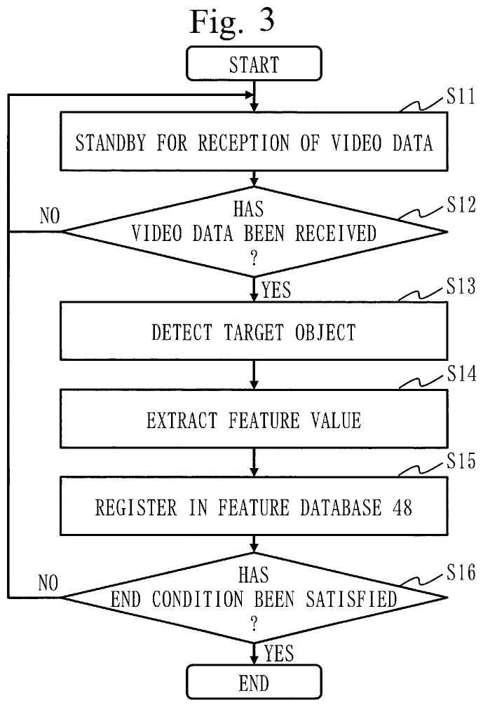

With reference to FIG. 3 to FIG. 7, the operation of the search system 100 according to Embodiment 1 is described.

The operation procedure of the search system 100 according to Embodiment 1 corresponds to a search method according to Embodiment 1. Also, a program for achieving the operation of the search system 100 according to Embodiment 1 corresponds to a search program according to Embodiment 1.

The operation of the search system 100 according to Embodiment 1 includes a collecting process of collecting a feature value, a search process of performing a search, and a threshold deriving process of deriving a threshold.

With reference to FIG. 3, a collecting process according to Embodiment 1 is described.

The collecting process always operates during operation of the search system 100.

### Step S11: Transmission Standby Process

The video data acquiring unit 31 of the feature extracting device 30 waits, after the activation of the device, for transmission of video data from any camera 10 sent via the hub 20. Note that the search device 40 may be always activated, or may be activated simultaneously with the feature extracting device 30.

### Step S12: Reception Determining Process

If not receiving video data, the video data acquiring unit 31 of the feature extracting device 30 causes the process to return to step S11.

On the other hand, if receiving video data, the video data acquiring unit 31 decodes the received video data, and outputs decoded video, which is video data obtained by decoding, to the target detecting unit 32. Here, a camera ID, which is an identifier of the camera 10 that took video data, and a time (=image-taking time) of receiving the video data are made as a set together with the decoded video and outputted. ID is an abbreviation of IDentifier.

Here, the camera ID can be identified by retaining a table indicating a correspondence between the IP address of each camera 10 and the camera ID in advance in the feature extracting device 30 and referring to that table. Alternatively, the IP address itself of each camera 10 may be used as a camera ID. This is not meant to be restrictive, and any information unique to each camera 10 allowing a link between the substance of the camera 10 and video data being sent by some means can be used as a camera ID.

### Step S13: Target Extracting Process

The target detecting unit 32 of the feature extracting device 30 detects, in the decoded video outputted at step S12, a person, which is a target object appearing in the decoded video. Then, the target detecting unit 32 outputs the detection result of the person, which is the detected target object, and the camera ID and the image-taking time that are made as a set together with the decoded video to the feature extracting unit 33.

Detection of the target object is performed with a scheme using image analyzing technology such as HoG. Detection of the target object may be performed with a scheme using a machine learning approach such as CNN, Faster R-CNN, or SSD. CNN is an abbreviation of Convolutional Neural Network. Faster R-CNN is an abbreviation of Faster-Region-based CNN. SSD is an abbreviation of Single Shot Detector.

The target to be detected is required to match a feature value to be extracted in a process at step S14 described further below. For example, for a feature value requiring a whole-body image of a person, the target detecting unit 32 is required to detect a whole-body image of the person. For a feature value requiring a facial feature, the target detecting unit 32 is required to detect a facial image.

The detection result is an image obtained by cutting an image of the detected person out from the decoded video. The detection result may be a set of the decoded video and position information in the video where the person has been detected. When the feature extracting unit 33 has means of accessing recorded decoded video, the detection result may be a set of information with which a frame number of the recorded decoded video can be identified and position information in the video where the person has been detected.

Also, depending on the feature value extracted in the process at step S14 described further below, a plurality of successive frames may be required. For example, when a feature value of a motion of a person is to be extracted, a plurality of successive frames are required. In this case, the target detecting unit 32 is required to output the result of continuously detecting the same person over a plurality of frames as the detection result.

### Step S14: Feature Extracting Process

The feature extracting unit 33 of the feature extracting device 30 extracts a feature value from the detection result outputted at step S13.

The feature value extracted herein is a feature value from which similarity of the person can be calculated. For example, the feature value indicates an image feature such as Hog. Alternatively, the feature value indicates vector data or the like obtained by applying deep learning and converting an image feature of the whole body of a person into a comparable form. When the detection result is the result of continuously detecting the same person over a plurality of frames, the feature value may indicate a gait feature, which is a feature of a way of walking of that person, or the like. The gait feature includes a cycle and width of swinging the arms and the legs, a cycle and width of swinging of the upper body, proportion, posture, and so forth. When the detection result is the result of continuously detecting the same person over a plurality of frames, the feature value may be information obtained by extracting a feature value obtainable from a single frame in each frame of the plurality of frames and making them as a set.

### Step S15: Registering Process

The feature extracting unit 33 of the feature extracting device 30 makes the feature value extracted at step S14 as a set together with the camera ID and the image-taking time outputted at step S13 and outputs the result to the search device 40.

Then, the feature acquiring unit 41 of the search device 40 outputs the set of the feature value and the camera ID and the image-taking time outputted by the feature extracting unit 33 to the database registering unit 42. The database registering unit 42 registers the set of the feature value and the camera ID and the image-taking time outputted by the feature acquiring unit 41 in the feature database 48 as a new feature value record.

Note that the database registering unit 42 may appropriately delete, from among records in the feature database 48, a record after the elapse of a predetermined time period from registration. When registering a new record, the database registering unit 42 may save the new record as overwriting an obsolete record. Alternatively, the database registering unit 42 may delete a record in the feature database 48 based on another rule.

### Step S16: End Determining Process

The database registering unit 42 of the search device 40 determines whether an end condition is satisfied. The end condition is, for example, an end request coming from a user. The end condition may be an end trigger occurring from another arrangement other than the search system 100, such as a timer.

When the end condition is satisfied, the database registering unit 42 ends the process. On the other hand, when the end condition is not satisfied, the database registering unit 42 causes the process to return to step S11.

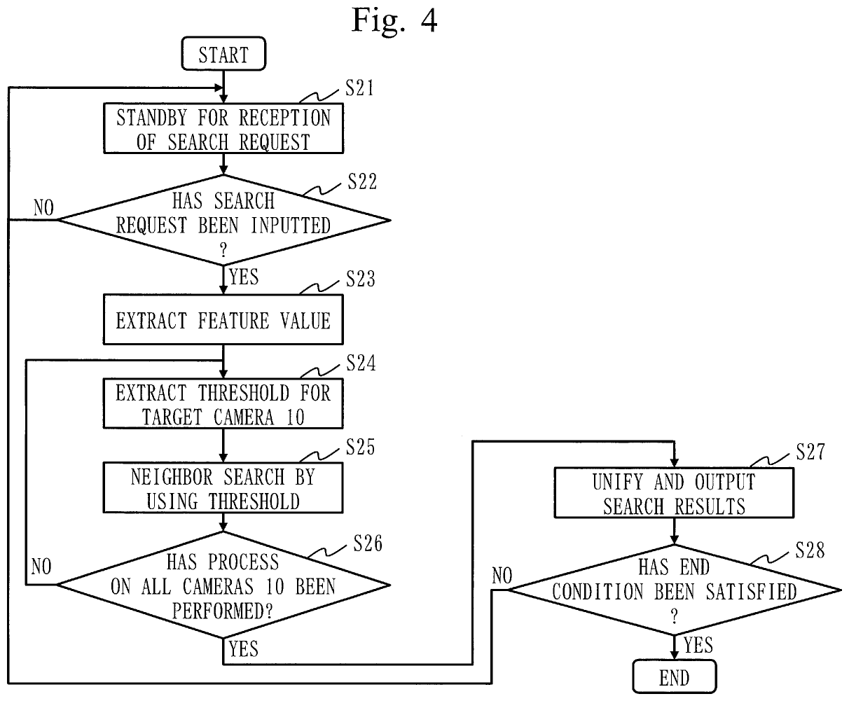

With reference to FIG. 4, a search process according to Embodiment 1 is described.

The search process operates by taking a request from a user as a trigger.

### Step S21: Input Standby Process

The request acquiring unit 43 of the search device 40 waits, after the activation of the device, for an input of a search request. The search request is inputted by the user. The search request includes image data of a search target person, which is a target object of a search target. The search request may include at least either the camera ID taking image data of the search target person or the image-taking time of the image data of the search target person.

### Step S22: Input Determining Process

When a search request is not inputted, the request acquiring unit 43 of the search device 40 causes the process to return to step S21.

On the other hand, when a search request is inputted, the request acquiring unit 43 acquires the search request, and outputs image data of the search target person included in the search request to the feature extracting unit 46. When information of at least either the camera ID or the image-taking time is included in the search request, the request acquiring unit 43 outputs the information included in the search request to the search unit 44.

The image data of the search target person is required to be an image from which a feature value for use in person search can be extracted. For example, when the feature value is a feature value of a whole-body image, the image data of the search target person is required to be a whole-body image satisfying a condition in which a whole-body image feature can be extracted. Also, the image data of the search target person may be a set of a plurality of pieces of image data. For example, the image data of the search target person may be a set of pieces of image data taken from a plurality of orientations or a set of images with variety in attire.

The camera ID and the image-taking time are used for identifying a starting point of the search. For example, if image data of the search target person is taken by any camera 10 in a target area, the camera ID and the image-taking time are the camera ID of the camera 10 taking that image data and a time of image taking. Also, the camera ID and the image-taking time may be the camera 10 taking an image of a location estimated from a testimony of witnessing the target person or the like and an estimated image-taking time. Also, the camera ID and the image-taking time may be identified from some electronic log information linked to the search target person, such as IC card touch information, two-dimensional code read information, or beacon reception records.

### Step S23: Feature Extracting Process

The feature extracting unit 46 of the search device 40 extracts a feature value as a search feature from the image data of the search target person outputted at step S22. When a plurality of pieces of image data of the search target person are included in the search request, the feature extracting unit 46 extracts a feature value from each piece of image data. The feature value extracted herein is a feature value equal to the feature value extracted at step S14 of FIG. 3. The feature extracting unit 46 outputs the extracted search feature to the search unit 44.

Based on the determining process at step S26, by taking each camera 10 as a target camera 10, processes at step S24 and step S25 are performed. In Embodiment 1, the search system 100 includes N cameras 10 from the camera 10-1 to the camera 10-N. Thus, for each integer i where i=1, . . . , N, by taking the camera 10-i as the target camera 10, the processes at step S24 and step S25 are performed.

### Step S24: Threshold Extracting Process

By using the feature value outputted by the feature extracting unit 46, the search unit 44 of the search device 40 acquires a threshold for use in search from the threshold database 49 as a target threshold.

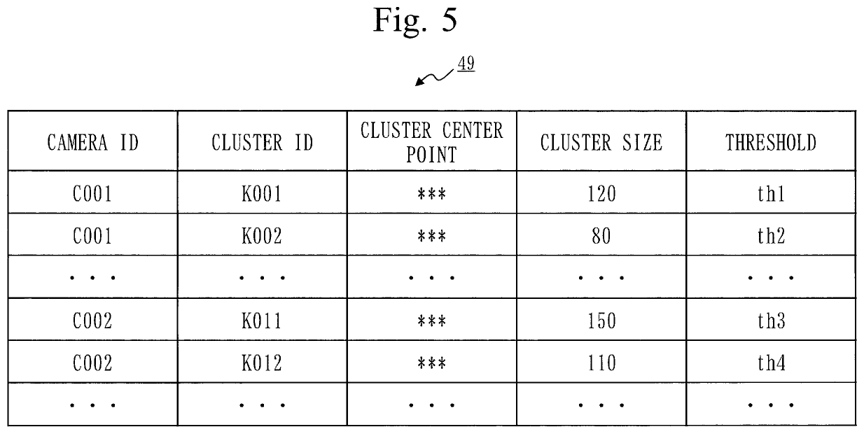

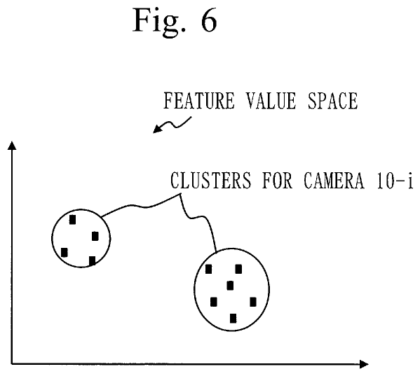

With reference to FIG. 5 and FIG. 6, description is specifically made.

In the threshold database 49, records are stored by a threshold deriving process described further below. As depicted in FIG. 5, in the threshold database 49, with each camera 10 being taken as the target camera 10 and each cluster for the target camera 10 being taken as a target cluster, records for the target camera 10 and the target cluster are stored. Specifically, for the target camera 10 and the target cluster, records including a camera ID, a cluster ID, a cluster center point, a cluster size, and a threshold are stored.

As depicted in FIG. 6, clusters for each camera 10 are acquired by clustering a plurality of feature values for a person, who is a target object appearing in the image data acquired by that camera 10. Here, the number of clusters for the camera 10-i is taken as Di (2 in FIG. 6).

The cluster center point is an average value of feature values belonging to a cluster. The cluster center point may be a barycenter of the feature values belonging to the cluster. Also, the cluster center point may be, among the feature values belonging to the cluster, a feature value with a smallest distance average with respect to other feature values.

The cluster size is an average value of distances between the cluster center point and the feature values belonging to the cluster. The cluster size may be an index such as dispersion, standard deviation, or the like of the feature values belonging to the cluster.

The cluster center point and the cluster size are information for allowing a cluster presence position and range on a space of the feature values to be identified. Thus, not only the cluster center point and the cluster size but also region information of each region obtained by Voronoi tessellation of the space of the feature values based on the cluster center point may be included in each record.

The search unit 44 identifies a cluster to which the search feature outputted at step S23 belongs, from among the plurality of clusters for the target camera 10-i. The search unit 44 acquires, from the threshold database 49, a threshold in a record corresponding to the target camera 10-i and the identified cluster as a target threshold.

The search unit 44 identifies the cluster to which the search feature belongs, by the following Method 1 or Method 2.

(Method 1) The search unit 44 calculates a distance between the cluster center point of each of the plurality of clusters for the target camera 10-i and the search feature. The search unit 44 identifies a cluster with a shortest calculated distance as a cluster to which the search feature belongs.

(Method 2) The search unit 44 sets each of the plurality of clusters for the target camera 10-i as a calculation target cluster. The search unit 44 calculates a distance between the cluster center point of the calculation target cluster and the search feature. The search unit 44 divides the calculated distance by the cluster size of the calculation target cluster. The search unit 44 identifies a cluster with a smallest calculated value as a cluster to which the search feature belongs.

Note that when the region information obtained by Voronoi tessellation is included in the record of the threshold database 49, the search unit 44 may identify a cluster to which the search feature belongs based on the region information.

### Step S25: Neighbor Search Process

The search unit 44 of the search device 40 performs a neighbor search with reference to the search feature, and identifies a record having a feature close to the search feature from among the plurality of records for the target camera 10-i stored in the feature database 48.

Specifically, the search unit 44 sets the threshold acquired at step S24 as a target threshold. The search unit 44 identifies one or more feature values corresponding to the search feature from among the feature values of the plurality of records for the target camera 10-i stored in the feature database 48. Here, from among the feature values of the plurality of records for the camera 10-i, the search unit 44 identifies one or more feature values with a distance from the search feature being equal to or smaller than the target threshold. The search unit 44 identifies a record corresponding to the identified feature value as a record having a feature close to the search feature.

### Step S26: Camera Determining Process

The search unit 44 of the search device 40 determines whether the processes at step S24 and step S25 have been performed by taking all cameras 10 as target cameras 10. If performed, the search unit 44 causes the process to proceed to step S27. On the other hand, if not performed, the search unit 44 causes the process to return to step S24, and performs the process by taking a new camera 10 as the target camera 10.

### Step S27: Output Process

The output unit 45 of the search device 40 outputs the record identified at step S25 by taking each camera 10 as the target camera 10. Here, the output unit 45 outputs the record identified at step S25 after organized, unified, or converted into a form that can be easily handled as a search result.

As an example of organizing, the records are systematically arranged. For example, the search unit 44 systematically arranges the records in order from a record having a feature value with high similarity with the search feature. By systematically arranging the records in order from a record having a feature value with high similarity, it is possible to present the records to the user in order from a record with high reliability.

By taking each record identified at step S25 as a target record, the output unit 45 calculates similarity Sim by using a distance between the feature value of the target record and the search feature and a threshold Tᵢₖ used when the target record is identified at step S25. Specifically, the output unit 45 calculates the similarity Sim from a value obtained by dividing the distance by the threshold Tᵢₖ, as represented by expression 1.

$$Sim = 1 - Dist / {T}_{i k} \qquad ( Expression 1 )$$

Dist is a distance between the feature value of the target record and the search feature. Tᵢₖ is a threshold used when the target record is identified. Since the distance is equal to or smaller than the threshold Tᵢₖ, the similarity Sim has a value obtained by normalization with 0 to 1. Also, as described further below, the threshold Tᵢₖ is configured to be larger as the cluster is larger in size. Thus, by calculating similarity with expression 1, the records are systematically arranged with almost actual similarity, irrespective of the cluster size. Note that a cluster in a large size is a cluster with a large distance between feature values even if a person has a similar outer appearance.

Note that the search unit 44 may systematically arrange the records not in order of similarity but in order from newest to oldest or from oldest to newest image-taking times. Also, the search unit 44 may systematically arrange the records in order of values obtained by combining similarity, time, and other information with a degree of priority.

As an example of unification, a typical record is extracted. For example, it is assumed that a plurality of records for video data having close image-taking times and acquired by the cameras 10 that are the same or nearby are included in the records identified at step S25. In this case, the search unit 44 retains only a part that is typical of the plurality of these records and excludes the rest. The output unit 45 outputs only the records not excluded but retained.

As an example of conversion, necessary information is extracted from the record and necessary information is added. For example, from the information included in the record, the search unit 44 extracts the image-taking time, the camera ID, and an image with a rectangle surrounding the person superposed on a cutout image of the person or a video frame where the person appears. Then, the search unit 44 adds a search reliability score for the person to the extracted information and outputs the result. The search reliability score may be, for example, the above-described similarity or a distance.

### Step S28: End Determining Process

The search unit 44 of the search device 40 determines whether an end condition is satisfied. The end condition is, for example, an end request coming from a user. The end condition may be an end trigger occurring from another arrangement other than the search system 100, such as a timer.

When the end condition is satisfied, the search unit 44 ends the process. On the other hand, when the end condition is not satisfied, the search unit 44 causes the process to return to step S21.

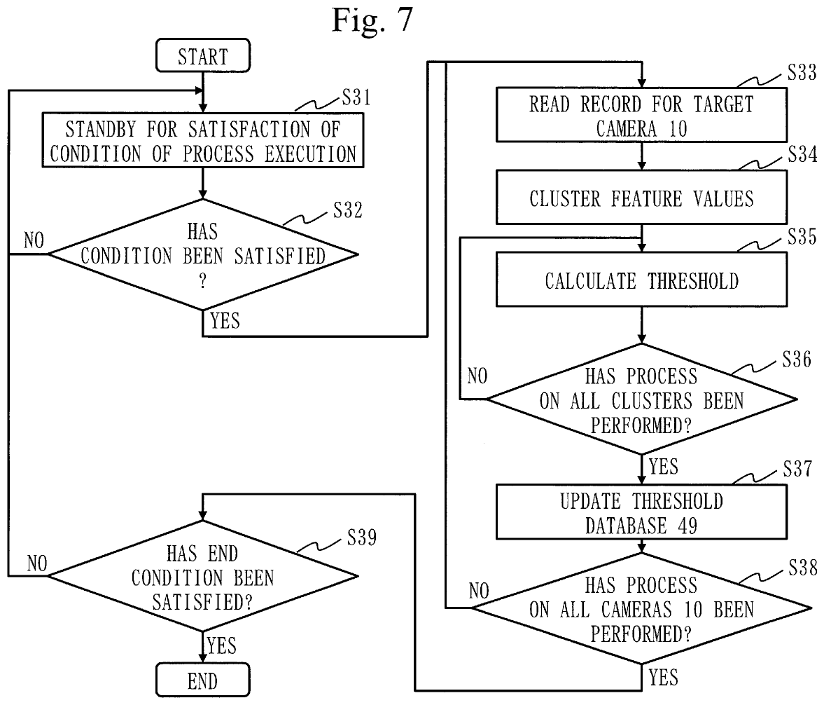

With reference to FIG. 7, a threshold deriving process according to Embodiment 1 is described.

The threshold deriving process operates by taking a condition satisfaction as a trigger.

### Step S31: Execution Standby Process

The threshold deriving unit 47 of the search device 40 waits, after the activation of the device, for satisfaction of a condition.

The condition is any one of the following (A) to (D) or a combination of two or more thereof. (A) A predetermined time has elapsed after execution of the previous threshold deriving process. (B) The number of records accumulated in the feature database 48 exceeds a predetermined number. (C) The number of records including a specific camera ID in the feature database 48 exceeds a predetermined number. (D)

Execution of a threshold deriving process is requested from the user.

### Step S32: Condition Determining Process

When the condition is not satisfied, the threshold deriving unit 47 of the search device 40 causes the process to return to step S31. On the other hand, when the condition is satisfied, the threshold deriving unit 47 causes the process to proceed to step S33.

Based on the determining process at step S38, by taking each camera 10 as a target camera 10, processes from step S33 to step S37 are performed. In Embodiment 1, the search system 100 includes N cameras 10 from the camera 10-1 to the camera 10-N. Thus, for each integer i where i=1, . . . , N, by taking the camera 10-i as the target camera 10, the processes from step S33 to step S37 are performed.

### Step S33: Reading Process

The threshold deriving unit 47 of the search device 40 reads a record for the target camera 10-i from the feature database 48.

The threshold deriving unit 47 may read all records for the target camera 10-i. Also, the threshold deriving unit 47 may read only part of the records obtained by sampling the records for the target camera 10-i in a random manner. Also, the threshold deriving unit 47 may read, among the records for the target camera 10-i, only a record limited to a specific condition such as a time zone such as nighttime and a season.

### Step S34: Clustering Process

The threshold deriving unit 47 of the search device 40 clusters the feature values in the record read at step S33 on a feature value space.

The threshold deriving unit 47 can perform clustering by using an existing algorithm such as k-Means algorithm, Mean Shift, or Gaussian Mixture Model. Alternatively, the threshold deriving unit 47 may divide the feature value space into partial spaces in a fixed size and handle each partial space as one cluster.

Here, for the target camera 10-i, it is assumed that feature values are clustered into k clusters from a cluster Dᵢ₁ to a cluster Dᵢₖ.

Based on the determining process at step S36, by taking each cluster as a target cluster, the process at step S35 is performed. Here, there are k clusters from the cluster Dᵢ₁ to a cluster Dᵢₖ. Thus, by taking a cluster Dᵢⱼ for each integer j where j=1, . . . , k as a target cluster, the process at step S35 is performed.

### Step S35: Threshold Calculating Process

The threshold deriving unit 47 of the search device 40 calculates a threshold for the target cluster Dᵢⱼ from a distribution of the target cluster Dᵢⱼ.

An object of deriving this threshold is to solve a problem in which a distance between feature values fluctuates for each location in the feature value space. Thus, an index value corresponding to a distance between feature values is identified for each cluster, and a threshold is calculated in accordance with the index value. For example, the threshold deriving unit 47 identifies dispersion or standard deviation from the cluster center point of the target cluster Dᵢⱼ as an index value. The threshold deriving unit 47 may take an average value of distances from a nearest feature value for each feature value belonging to the target cluster Dᵢⱼ as an index. The threshold deriving unit 47 calculates a threshold by multiplying the index by a fixed coefficient.

### Step S36: Cluster Determining Process

The threshold deriving unit 47 of the search device 40 determines whether the process at step S35 has been performed by taking all clusters as target clusters. If performed, the threshold deriving unit 47 causes the process to proceed to step S37. On the other hand, if not performed, the threshold deriving unit 47 causes the process to return to step S35, and performs the process by taking a new cluster as a target cluster.

### Step S37: Threshold Updating Process

The threshold deriving unit 47 of the search device 40 updates the threshold for the target camera 10-i in the threshold database 49 with the threshold calculated at step S35. The structure of the threshold database 49 is as depicted in FIG. 5.

Specifically, the threshold deriving unit 47 deletes the record of the target camera 10-i in the threshold database 49. Then, for the target camera 10-i, the threshold deriving unit 47 registers a record of the cluster Dᵢⱼ for each integer j where j=1, . . . , k in the threshold database 49. Here, the threshold deriving unit 47 calculates a cluster center point and a cluster size and sets them in the respective sections. Also, the threshold deriving unit 47 sets the threshold calculated at step S35 in a threshold section.

### Step S38: Camera Determining Process

The threshold deriving unit 47 of the search device 40 determines whether the processes from step S33 to step S37 have been performed by taking all cameras 10 as target cameras 10. If performed, the threshold deriving unit 47 causes the process to proceed to step S39. On the other hand, if not performed, the threshold deriving unit 47 causes the process to return to step S33, and performs the process by taking a new camera 10 as the target camera 10.

### Step S39: End Determining Process

The threshold deriving unit 47 of the search device 40 determines whether an end condition is satisfied. The end condition is, for example, an end request coming from a user. The end condition may be an end trigger occurring from another arrangement other than the search system 100, such as a timer.

When the end condition is satisfied, the threshold deriving unit 47 ends the process. On the other hand, when the end condition is not satisfied, the threshold deriving unit 47 causes the process to return to step S31.

### Effects of Embodiment 1

As described above, the search system 100 according to Embodiment 1 derives a threshold in advance for each cluster obtained by clustering feature values, and performs a search by using a threshold for a cluster corresponding to a search feature. With this, a search is performed by using an appropriate threshold corresponding to the search feature, and a target object can be appropriately searched for.

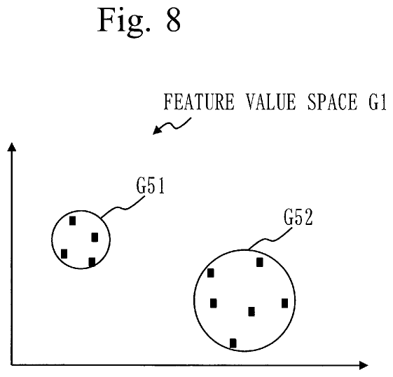

With reference to FIG. 8, effects of the search system 100 according to Embodiment 1 are specifically described.

In FIG. 8, an image with feature values plotted on a feature value space G1 is depicted. Each of a feature value group G51 and a feature value group G52 is a distribution configured of feature values of similarly-dressed persons. The feature value group G51 is a distribution of persons dressed in deep color on both of the upper and lower bodies. The feature value group G52 is a distribution of persons dressed in light color on the upper body and in deep color on the lower body.

In FIG. 8, the dispersion of the distribution is small in the feature value group G51, and the dispersion of the distribution is large in the feature value group G52. In this case, a person dressed as indicated in the feature value group G51 can be identified with a relatively small threshold. On the other hand, it is not possible to identify a person dressed as indicated in the feature value group G52 without a relatively large threshold. In this manner, an appropriate threshold may vary for each outer appearance of the target object. In this case, if an across-the-board threshold is set for the cameras 10, identification accuracy changes depending on the outer appearance of the target object.

By contrast, in the search system 100 according to Embodiment 1, a search is performed by using the threshold for the cluster corresponding to the search feature. Thus, the threshold for use changes depending on which of the feature value group G51 and the feature value group G52 to which the search feature belongs. This allows the target object to be appropriately searched for.

### Other Structures

### Modification 1

In Embodiment 1, at step S27 of Fig, 4, the output unit 45 outputs the identified record after organized, unified, or converted into a form that can be easily handled as a search result. As Modification 1, the output unit 45 may estimate a moving path of a search target person from the identified record and output the estimated moving path.

A moving path estimating method is specifically described.

(1) As described as an example of unification at step S27 of FIG. 4, the output unit 45 retains only a part of the records that is typical from the records for video data having close image-taking times and acquired by the cameras 10 that are the same or nearby, and excludes the rest. (2) The output unit 45 systematically arranges the records not excluded but retained in order of the image-taking time. (3) The output unit 45 plots the installation positions of the cameras 10 identified from the camera IDs in the records, and connects them with arrows in the order of the arrangement of the records. A path indicated by the plotted points and the arrows is a moving path of the search target person.

Here, based on the reliability of the record identified at step S25 and the probability of attainment of movement between the cameras 10 in the moving path, the output unit 45 calculates a likelihood of the moving path by statistical processing. Then, the output unit 45 outputs the likelihood together with the moving path.

The reliability of the record is a distance between the feature value of that record and the search feature. The reliability of the record may be similarity described in the example of organizing at step S27 of FIG. 4. The probability of attainment of movement is a probability calculated from, for example, whether the person can move without being image-taken by another camera 10, whether the movement can be made in consideration of the image-taking time, or the like.

Note that the output unit 45 may estimate a plurality of moving paths for a single search target person by, for example, changing a method of selecting a part of the records that is typical described in (1). Then, the output unit 45 may output each moving path together with the likelihood.

### Modification 2

In Embodiment 1, each functional component is implemented by software. However, as Modification 2, each functional component may be implemented by hardware. As for this Modification 2, portions that are different from those of Embodiment 1 are described.

When each functional component is implemented by hardware, the feature extracting device 30 and the search device 40 each include an electronic circuit, in place of the processor 101, the memory 102, and the storage 103. The electronic circuit is a dedicated circuit implementing the functions of each functional component, the memory 102, and the storage 103.

As an electronic circuit, a single circuit, composite circuit, programmed processor, parallel-programmed processor, logic IC, GA, ASIC, or FPGA is assumed. GA is an abbreviation of Gate Array. ASIC is an abbreviation of Application Specific Integrated Circuit. FPGA is an abbreviation of Field-Programmable Gate Array.

Each functional component may be implemented by a single electronic circuit, or each functional component may be implemented by being distributed into a plurality of electronic circuits.

### Modification 3

As Modification 3, part of the functional components may be implemented by hardware and the others of the functional components may be implemented by software.

The processor 101, the memory 102, the storage 103, and the electronic circuit are referred to as processing circuits. That is, the function of each functional component is implemented by a processing circuit.

Note that “unit” in the foregoing description may be read as “circuit”, “step”, “procedure”, “process”, or “processing circuit”.

In the foregoing, the embodiment and the modifications of the present disclosure have been described. Among these embodiment and modifications, several ones may be combined for implementation. Also, any one or several ones may be partially implemented. Note that the present disclosure is not limited to the above-described embodiment and modifications and can be variously changed as required.

### Reference Signs List

100: search system; 10: camera; 20: hub; 30: feature extracting device; 31: video data acquiring unit; 32: target detecting unit; 33: feature extracting unit; 40: search device; 41: feature acquiring unit; 42: database registering unit; 43: request acquiring unit; 44: search unit; 45: output unit; 46: feature extracting unit; 47: threshold deriving unit; 48: feature database; 49: threshold database

1. A search device comprising:
processing circuitry:
to derive, by taking each of a plurality of clusters obtained by clustering a plurality of feature values stored in a feature database as a target cluster, a threshold for the target cluster from a distribution of the feature values in the target cluster; and
to identify, by using, as a target threshold, the threshold derived for a cluster to which a search feature, which is a feature value for an image in a search request, belongs among the plurality of clusters, a feature value corresponding to the search feature from the plurality of feature values stored in the feature database.

2. The search device according to claim 1, wherein
in the feature database, the plurality of feature values for a target object appearing in image data acquired by a plurality of cameras are stored,
by taking each of the plurality of cameras as a deriving target camera, the processing circuitry derives the threshold for the plurality of clusters obtained by clustering the plurality of feature values for the target object appearing in the image data acquired by the deriving target camera, and
by taking each of the plurality of cameras as a search target camera and by using, as the target threshold, the threshold for the cluster to which the search feature, which is the feature value for the image in the search request, belongs among the plurality of clusters for the search target camera, the processing circuitry identifies the feature value corresponding to the search feature from the feature values for the target object appearing in the image data acquired by the search target camera.

3. The search device according to claim 1, wherein
the processing circuitry identifies, from among the plurality of feature values, a feature value with a distance from the search feature being equal to or smaller than the target threshold.

4. The search device according to claim 2, wherein
the processing circuitry identifies, from among the plurality of feature values, a feature value with a distance from the search feature being equal to or smaller than the target threshold.

5. The search device according to claim 3, wherein
the processing circuitry to calculate, by taking each of one or more feature values identified as a target feature value, similarity between the target feature value and the search feature from a value obtained by dividing the distance between the target feature value and the search feature by the target threshold used when the target feature value is identified.

6. The search device according to claim 4, wherein
the processing circuitry to calculate, by taking each of one or more feature values identified as a target feature value, similarity between the target feature value and the search feature from a value obtained by dividing the distance between the target feature value and the search feature by the target threshold used when the target feature value is identified.

7. The search device according to claim 5, wherein
the processing circuitry systematically arranges and outputs information about the one or more identified feature values in order of the similarity.

8. The search device according to claim 6, wherein
the processing circuitry systematically arranges and outputs information about the one or more identified feature values in order of the similarity.

9. A search method comprising:
deriving, by taking each of a plurality of clusters obtained by clustering a plurality of feature values stored in a feature database as a target cluster, a threshold for the target cluster from a distribution of the feature values in the target cluster; and
identifying, by using, as a target threshold, the threshold derived for a cluster to which a search feature, which is a feature value for an image in a search request, belongs among the plurality of clusters, a feature value corresponding to the search feature from the plurality of feature values stored in the feature database.

10. A non-transitory computer readable medium storing a search program that causes a computer to function as a search device to execute:
a threshold deriving process of deriving, by taking each of a plurality of clusters obtained by clustering a plurality of feature values stored in a feature database as a target cluster, a threshold for the target cluster from a distribution of the feature values in the target cluster; and
a search process of identifying, by using, as a target threshold, the threshold derived by the threshold deriving process for a cluster to which a search feature, which is a feature value for an image in a search request, belongs among the plurality of clusters, a feature value corresponding to the search feature from the plurality of feature values stored in the feature database.
